(19) United States
(12) Patent Application Publication
(10) Pub. No.: US 2010/0275521 A1
(43) Pub. Date: Nov. 4, 2010

(54) WINDOW SASH FRAME

(75) Inventor: Rolf J. Ohrstrom, Richmond Hill (CA)

Correspondence Address: BERESKIN AND PARR LLP/S.E.N.C.R.L., s.r.l., 40 KING STREET WEST, BOX 401, TORONTO, ON, M5H 3Y2, CA

(73) Assignee: VISION EXTRUSIONS LIMITED, Woodbridge (CA)

(21) Appl. No.: 12/770,297

(22) Filed: Apr. 29, 2010

(30) Foreign Application Priority Data
Apr. 29, 2009 (CA) 2664871

(51) Int. Cl. E05C 19/00; E06B 3/34

(52) U.S. Cl. 49/504

(57) ABSTRACT

A window sash frame comprises a horizontally extending upper rail comprising a first end and a laterally opposed second end. The upper rail further comprises an integrally formed upper wall, lower wall, intermediate wall, front wall, and back wall extending between the first and second ends. The upper wall, lower wall, and intermediate wall extend parallel to the horizontal plane. The front wall and back wall extend parallel to the vertical plane. The intermediate wall comprises an upper seating surface facing the upper wall. The upper wall, intermediate wall, front wall and back wall define a horizontally extending channel within the upper rail. A first opening is provided in the upper wall and provides access to the channel. The window sash frame further comprises a first latch bolt slidably received in the channel.

This application claims the benefit of Canadian Application No. 2,664,871, filed Apr. 29, 2009, which is hereby incorporated herein by reference.

### FIELD

The specification relates to window sash frames. More particularly, the specification relates to window sash frames which are pivotally mounted in master frames.

### INTRODUCTION

The following is not an admission that anything discussed below is prior art or part of the common general knowledge of persons skilled in the art.

U.S. Pat. No. 5,139,291 (Schultz) discloses a pivot latch adapted for releasably securing a pivotable sash window to a master frame. The master frame has opposed, vertically extending guide rails. The sash has a hollow top sash rail, a base and a pair of hollow stiles cooperatively connected together at adjacent extremities thereof to form a rectangular sash frame. The top sash rail includes a pair of opposing header slots. Each of the header slots forms a pair of opposing, longitudinal header rails. The pivot latch comprises a housing having an outward end opening. A latch bolt is disposed within the housing. The pivot latch further includes a spring for biasing the latch bolt outwardly through the outward end opening and is adapted for engaging one of the guide rails. The housing has a cover having longitudinal edges and a pair of side walls depending from the cover and disposed inward of the edges. Each of the side walls has a side wall rail which cooperates with a respective one of the housing cover edges to form a longitudinal groove adapted to cooperatively receive a respective pair of the header rails. A tab depending from the housing is provided for engaging a respective one of the stiles to retain the tilt latch in position. A method of manufacturing a pivotable sash window including such a pivot latch is also disclosed.

U.S. Pat. No. 6,230,443 (Schultz) discloses a hardware mounting which has one preferred embodiment as a tilt-latch. The tilt-latches adapted for releasably securing a pivotable sash window disposed within opposed guide rails on a master frame of a window sash assembly. The sash window comprises a top sash rail, a base and two stiles connected together at their extremities. The top sash rail has an intermediate wall having an opening. The tilt-latch comprises a housing adapted to be supported in the top rail. The housing further has an outward end opening and a bottom wall. The housing has a tab depending from the bottom wall adapted to be received by the intermediate wall opening. The housing also has a latch bolt disposed within the housing and having a nose adapted for engaging a respective one of the guide rails.

U.S. Pat. No. 6,832,792 (Polowinczak et al.) discloses a tilt-latch adapted for releasably securing a sash window to a master frame of a window sash assembly. The tilt-latch comprises a housing having an outward end opening and an inner wall. A latch bolt is disposed within the housing and has a nose adapted for engaging a respective one of a pair of guide rails of the window assembly. The latch bolt also has at least one protrusion. The latch bolt is moveable between a deployed position wherein the nose extends through the outward end opening and the protrusion is spaced from the inner wall, and a retracted position wherein the protrusion) engages a trailing edge of the inner wall to maintain the latch bolt in the retracted position.

U.S. Pat. No. 6,874,826 (Polowinczak et al.) discloses a tilt-latch adapted for releasably securing a pivotable sash window disposed within opposed guide rails on a master frame of a window sash assembly. The sash window comprises a top sash rail, a base and two stiles connected together at their extremities. The tilt-latch comprises a housing adapted to be supported by the top rail. The housing has an outward end opening and a cover. A latch bolt is disposed within the housing and has a nose adapted for engaging a respective one of the guide rails. The latch bolt also has a slot. The tilt-latch further has an actuator having a post. The post is received by the slot. The tilt-latch also has a spring) for biasing the latch bolt through the outward end opening. The actuator is connected to the latch bolt and is sized to be positioned over the entire cover of the housing. The housing and latch bolt are made of plastic and the actuator is made from zinc.

U.S. Patent Application Publication 2007/0209281 (Flory et al.) discloses an integrated sash lock and tilt latch assembly that is mounted in a sash window having a top rail, a base, and two stiles connected together at their extremities. The integrated assembly contains a sash lock mechanism, a tilt latch mechanism, and a connector. The sash lock mechanism includes an actuator movable to adjust the assembly among a locked position, an unlocked position, and a tiltable position, and a rotor coupled to the actuator. The tilt latch mechanism includes a tilt latch housing supported by the top rail and a latch bolt slidably supported by the tilt latch housing and moveable between an extended position and a retracted position. At least a portion of the tilt latch housing has a generally circular cross-section. The connector has a first end of operably coupled to the latch bolt and a second end operably coupled to the sash lock mechanism.

### SUMMARY

The following introduction is provided to introduce the reader to the more detailed discussion to follow. The introduction is not intended to limit or define the claims.

According to one broad aspect, a window sash frame is provided. The window sash frame comprises a horizontally extending upper rail. The upper rail comprises a first end and a laterally opposed second end. The upper rail further comprises an integrally formed upper wall, lower wall, intermediate wall, front wall, and back wall extending between the first end and second end. The upper wall, lower wall, and intermediate wall extend parallel to the horizontal plane. The front wall and back wall extend parallel to the vertical plane. The intermediate wall comprises an upper seating surface facing the upper wall. The upper wall, intermediate wall, front wall and back wall define a horizontally extending channel within the upper rail. A first opening is provided in the upper wall and provides access to the channel. The window sash frame further comprises a first latch bolt slidably received in the channel and seated on the upper seating surface. The first latch bolt comprises an engagement end, and a grip portion aligned with the opening and accessible through the opening. The grip portion is usable to slide the first latch bolt between a locking position wherein the engagement end extends proud of one of the first end and the second end of the upper rail for engagement with a master frame in which the sash is mounted, and an unlocking position wherein the engagement end is retracted towards the other of the first end and the second end. A first biasing member is provided which biases the first latch bolt towards the locking position. The window sash frame further comprises a first vertically extending side rail and a second vertically extending side rail extending downward from the first and second ends of the upper rail, respectively, and a horizontally extending lower rail extending between the first and second side rails opposite the upper rail.

In some examples, the latch bolt comprises a lower surface, and a horizontally extending recess open to the lower surface. The first biasing member may comprise a horizontally extending spring received in the recess. In some examples, the first latch bolt further comprises an elongated slot extending vertically therethrough, and the window sash frame further comprises a slide pin extending vertically through the slot and secured to the intermediate wall. The first latch bolt may be slidable along the slide pin. A portion of the recess may provide a lower portion of the elongated slot, so that the slide pin extends through the recess, and the spring bears against the slide pin at one end thereof.

In some examples, the slide pin comprises a screw portion. A lower channel may be defined between the intermediate wall and the lower wall, and the screw portion may extend through the intermediate wall into the lower channel.

In some examples, the window sash frame further comprises a screw-support in the lower channel, and the screw portion may be screwable into the screw-support. The screw-support may be a separately formed insert provided in the lower channel. Alternately, the screw-support may comprise first and second ribs integrally formed with the upper rail and extending between the intermediate wall and the lower wall.

In some examples, the first opening is proximate the first end, and the engagement end extends proud of the first end in the locking position.

In some examples, the first and second ends of the upper rail are joined to the first and second side rails, respectively, at miter joints. The first side rail may have an aperture extending horizontally therethrough and aligned with the channel. The engagement end may be slidable through the aperture and positioned proud of the first side rail in the locking position.

In some examples, the grip is a downwardly extending indentation. The first latch bolt may further comprise an upwardly extending button mounted to the grip and extending through the opening.

In some examples, the window sash further comprises a second opening proximate the second end and providing access to the channel, and a second latch bolt slidably received in the channel and seated on the lower seating surface. The second latch bolt may comprise a second latch bolt engagement end, and a second latch bolt grip portion aligned with the second opening and accessible through the second opening. The second latch bolt grip portion may be usable to slide the second latch bolt between a second latch bolt locking position wherein the second latch bolt engagement end extends proud of the second end of the upper rail for engagement with the window frame, and a second latch bolt unlocking position wherein the second latch bolt engagement end is retracted towards the first end. A second biasing member may be provided for biasing the second latch bolt towards the locking position.

According to another broad aspect, a window sash frame is provided. The window sash frame comprises a horizontally extending upper rail. The upper rail comprises a first end and a longitudinally opposed second end. The upper rail further comprises an integrally formed upper wall, lower wall, intermediate wall, front wall, and back wall extending between the first end and second end. The upper wall, lower wall, and intermediate wall extend parallel to the horizontal plane, and the front wall and back wall extend parallel to the vertical plane. The upper wall, intermediate wall, and front and back walls define a horizontally extending channel within the upper rail. A first opening is provided in the upper wall, and provides access to the channel. The window sash frame further comprises a first latch bolt slidably received in the channel. The first latch bolt comprises an engagement end, an elongated slot extending vertically therethrough, and a grip portion aligned with the opening and accessible through the opening. A first slide pin is provided, which extends through the slot and is secured to the intermediate wall. The first latch bolt is horizontally slidable along the first slide pin using the grip portion. The first latch bolt is slidable between a locking position wherein the engagement end extends proud of one of the first end and the second end of the upper rail for engagement with a master frame in which the sash is mounted, and an unlocking position wherein the engagement end is retracted towards the other of the first end and the second end. A first biasing member is provided which biases the first latch bolt towards the locking position. The window sash frame further comprises a first vertically extending side rail, and a second vertically extending side rail extending downward from the first and second ends of the upper rail, and a lower horizontal rail extending between the first and second side rails opposite the upper rail.

In some examples, the first latch bolt comprises a lower surface and a horizontally extending recess open to the lower surface. The first biasing member may comprise a horizontally extending spring received in the recess. A portion of the recess may provide a lower portion of the elongated slot, so that the first slide pin extends through the recess. The spring may bear against the first slide pin at one end thereof.

In some examples, the first slide pin is a screw. A lower channel may be defined between the intermediate wall and the lower wall, and the screw may extend through the intermediate wall into the lower channel. The window sash frame may comprise a screw-support in the lower channel, and the screw may be screwable into the screw-support. The screw-support may be a separately formed insert provided in the lower channel. Alternately, the screw-support may comprise first and second ribs integrally formed with the upper rail and extending between the intermediate wall and the lower wall.

In some examples, the first opening is proximate the first end, and the engagement end extends proud of the first end in the locking position.

In some examples, the first and second ends of the upper rail are joined to the first and second side rails, respectively, at miter joints. The first side rail may have an aperture extending horizontally therethrough and aligned with the channel. The engagement end may be slidable through the aperture and may extend proud of the first side rail in the locking position.

In some examples, the grip portion is a downwardly extending indentation. The window sash may further comprise an upwardly extending button mounted to the grip portion and extending through the opening.

In some examples, the intermediate wall comprises an upper seating surface facing the upper wall, and the latch bolt is seated on the upper seating surface.

In some examples, the window sash frame further comprises a second opening proximate the second end and providing access to the channel, and a second latch bolt slidably received in the channel. The second latch bolt may comprise a second latch bolt engagement end, a second latch bolt elongated slot extending vertically therethrough, and a second latch bolt grip portion aligned with the second opening and accessible through the second latch bolt opening. A second fastener may be provided which extends through the second latch bolt slot and is secured to the intermediate wall. The second latch bolt may be horizontally slidable along the second fastener using the second latch bolt grip portion. The second latch bolt may be slidable between a second latch bolt locking position wherein the second latch bolt engagement end extends proud of the second end of the upper rail for engagement with the master frame, and a second latch bolt unlocking position wherein the second latch bolt engagement end is retracted towards the channel. A second biasing member may be provided biasing the second latch bolt towards the second locking position.

### DRAWINGS

The drawings included herewith are for illustrating various examples of articles, methods, and apparatuses of the present specification and are not intended to limit the scope of what is taught in any way. In the drawings:

FIG. 1 is a perspective illustration of an example of a window sash frame in a double hung window assembly and pivotally mounted to a master frame;

FIG. 2 is partial perspective exploded view of the window sash frame of FIG. 1;

FIG. 3 is a cross-section taken along line 3-3 in FIG. 2;

FIG. 4A is a top perspective illustration of the latch bolt, slide pin, and biasing member shown in FIG. 2;

FIG. 4B is a bottom perspective illustration of the latch bolt, slide pin, and biasing member shown in FIG. 4A;

FIG. 5 is a partial perspective illustration of the window sash frame of FIG. 1;

FIG. 6A is a cross section taken along line 6-6 in FIG. 5, showing the latch bolt in a locking position;

FIG. 6B is a cross section taken along line 6-6 in FIG. 5, showing the latch bolt in an unlocking position;

FIG. 7 is a cross-section taken along line 7-7 in FIG. 5;

FIG. 8 is a cross section taken along line 7-7 in FIG. 5, showing an alternate extrusion profile of a top rail, and showing a separately formed screw support;

FIG. 9 is a cross section taken along line 7-7 in FIG. 5, showing an further alternate extrusion profile of a top rail, and showing a separately formed screw support;

FIG. 10 is a cross section taken along line 7-7 in FIG. 5, showing the extrusion profile of FIG. 9, and showing an integrally formed screw support;

FIG. 11 is a cross section taken along line 7-7 in FIG. 5, showing an further alternate extrusion profile of a top rail, and showing a separately formed screw support; and

FIG. 12 is a cross section taken along line 3-3 in FIG. 2, showing an alternate extrusion profile of a top rail, and showing an integrally formed screw support.

### DETAILED DESCRIPTION

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. The applicants, inventors or owners reserve all rights that they may have in any invention disclosed in an apparatus or process described below that is not claimed in this document, for example the right to claim such an invention in a continuing application and do not intend to abandon, disclaim or dedicate to the public any such invention by its disclosure in this document.

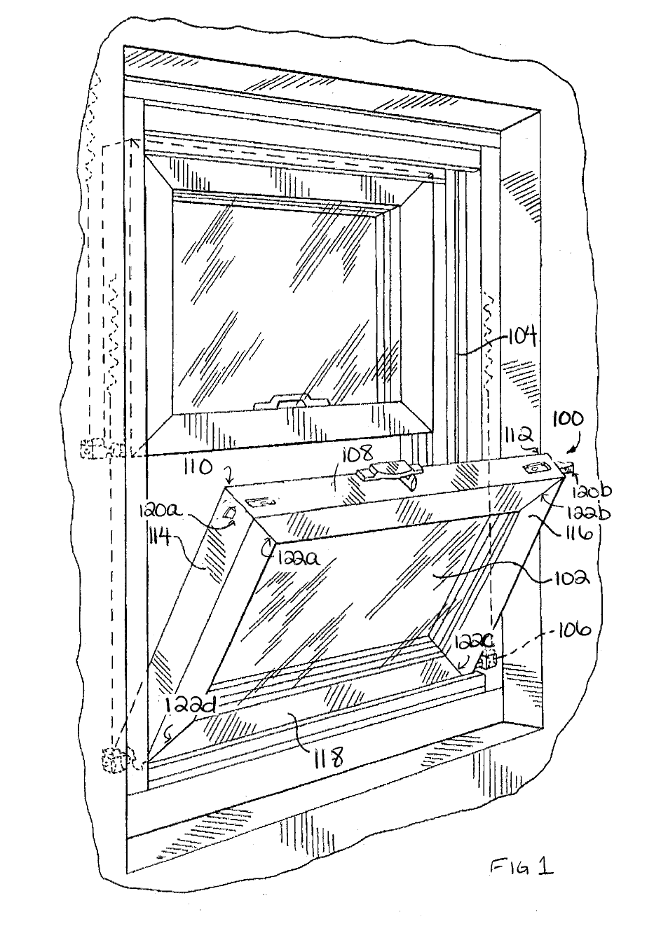

Referring to FIG. 1, an example of a window sash frame 100 is shown. The window sash frame 100 supports a glazing 102, such as a glass panel. As shown, the window sash frame 100 is part of a double-hung window assembly, and is installed in a master frame 104. The window sash frame 100 is vertically slidable in the master frame 104, so that the window assembly may be opened. Further, the window sash frame 100 is pivotally mounted in the master frame 104, so that window sash frame 100 may be pivoted open, as shown in FIG. 1, and the exterior surface of the glazing 102 may be accessed and cleaned, for example. As shown, the window sash frame 100 is pivotally mounted to the master frame 104 by a sash balance/brake shoe assembly 106. As will be described further hereinbelow, the window sash frame comprises a first 120a and a second 120b latch bolt, which releasably locks the window sash frame 100 to the master frame 104, so that the window sash frame 100 may be locked in a pivotally closed position, and may be unlocked and pivotally opened.

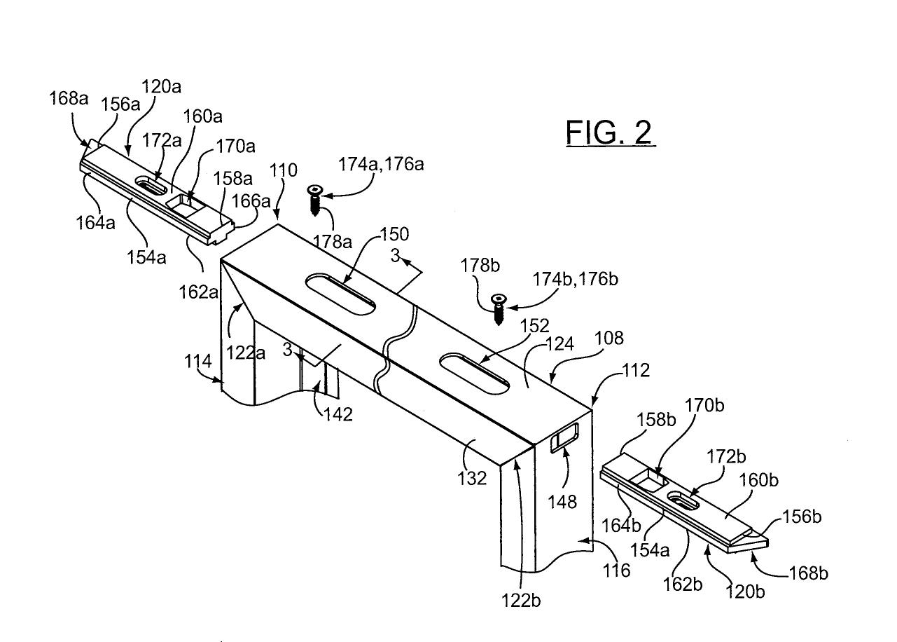

Referring to FIGS. 1 and 2, the window sash frame 100 comprises a horizontally extending upper rail 108 comprising a first end 110 and a laterally opposed second end 112. A first vertically extending side rail 114 extends downwardly from the first end 110 of the upper rail 108, and a second vertically extending side rail 116 extends downwardly from the second end 112 of the upper rail 108. A horizontally extending lower rail 118 extends between the first 114 and second 116 side rails opposite the upper rail (shown only in FIG. 1).

It will be appreciated that the terms “horizontal” and “vertical” are intended to refer to general relative directions in which various portions of the sash frame 100 are positioned when in use. The terms “horizontal” and “vertical” are intended to include deviations from true horizontality and verticality which may occur during normal use.

As shown in FIG. 1, the upper rail 108, side rails 114, 116, and lower rail 118 are joined together at miter joints 122a-122d. In alternate examples, the upper rail 108, side rails 114, 116, and lower rail 118 may be joined together at another type of joint, such as a butt joint. The upper rail 108, side rails 114, 116, and lower rail 118 may be joined together in any suitable fashion, such as by welding, adhesives, or fasteners, for example.

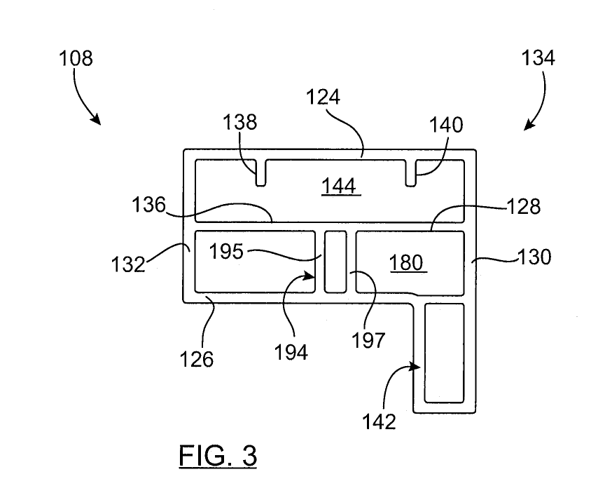

Referring now to FIGS. 2 and 3, the upper rail 108 comprises an upper wall 124, a lower wall 126, an intermediate wall 128, a front wall 130, and a back wall 132, each of which extends between the first end 110 and second ends 112. As shown, the upper wall 124, lower wall 126, intermediate wall 128, front wall 130, and back wall 132 are integrally formed. For example, the upper rail may be fabricated by extrusion of a plastic material.

Preferably, the upper rail 108, side rails 114, 116, and lower rail 118 are each made from a single extrusion of a plastic material that is cut to length. For example, the extrusion profile 134 shown in FIG. 3 may be common to the upper rail 108, side rails 114, 116, and lower rail 118, so that they are interchangeable.

Referring still to FIGS. 2 and 3, the upper wall 124, lower wall 126, and intermediate wall 128 extend generally parallel to the horizontal plane. The intermediate wall 128 is provided above and spaced from the lower wall 126, and below and spaced from the upper wall 124. The intermediate wall 128 includes an upper seating surface 136, which faces the upper wall 124.

The front 130 and back 132 walls extend generally parallel to the vertical plane, and are provided on opposed sides of the upper 124, lower 126, and intermediate 128 walls. The front 130 and back 132 walls each extend between the upper wall 124 and the lower wall 126.

In the example shown, first 138 and second 140 support ribs extend downwardly from the upper wall 124. The ribs 138, 140 extend between the first 110 and second 112 ends of the upper rail 108 and parallel to the vertical plane. As shown, the ribs 138, 140 are integrally formed with the upper rail 108.

A glazing support 142 extends downwardly from the lower wall. Glazing support 142 is usable to support a glazing within window sash frame 100.

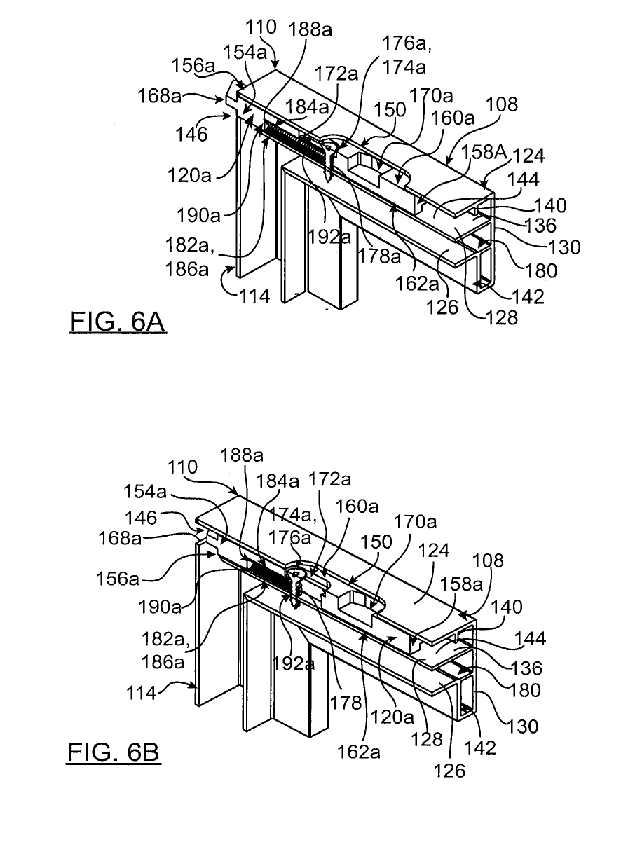

The upper wall 124, intermediate wall 128, front wall 130 and back wall 132 define a horizontally extending channel 144 within the upper rail 108. The channel extends laterally from the first end 110 of the upper rail 108 to the second end 112 of the upper rail 1080, and includes opposed open ends (not shown) at the first 110 and second 112 ends, respectively. The opposed open ends are open to the outside environment, so that the engagement ends 168a, 168b of latch bolts 120a, 120b, which are received in the channel 144, may be slid into and out of engagement with the master frame 104, as will be described hereinbelow. In the example shown, as mentioned hereinabove, the upper rail 108 is joined to the first 114 and second 116 side rails at miter joints 122a and 122b. Accordingly, in the example shown, the first side rail 114 has an aperture 146 (shown in FIGS. 6a and 6b) extending horizontally therethrough and aligned with the open end of the channel 144, and the second side rail 116 has an aperture 148 (shown in FIG. 2) extending horizontally therethrough and aligned with the open end of the channel 144, so that the engagement ends 168a, 168b of first 120a and second 120b latch bolts may be slid into and out of the apertures 146, 148 for engagement with master frame 104. In alternate examples, wherein the first 114 and second 116 side rails are joined to the upper rail 108 at a butt joint, apertures may not be provided in the first 114 and second 116 side rails, and the open ends of the channel 144 may be directly open to the outside environment, so that the engagement ends 168a, 168b of first 120a and second 120b latch bolts may be slid into and out of the open ends for engagement with master frame 104.

As shown in FIG. 2, a first opening 150 is provided in the upper wall 124 proximate the first end 110 of the upper rail 108. Further, a second opening 152 is provided in the upper wall 124, proximate the second end 112 of the upper rail 108. Each of the first 150 and second 152 openings provides access to the channel 144. The first 150 and second 152 openings may be formed, for example, by routing, or punching.

Referring now to FIGS. 2 and 4A-7, first 120a and second 120b latch bolts are slidably received in the channel 144. The first 120a and second 120b latch bolts are slidable to lock the window sash frame 100 in a pivotally closed position, and to unlock the window sash frame such that the window sash frame may be pivoted open, as shown in FIG. 1. The structure and function of the first latch bolt 120a will presently be described, and reference numerals ending with the letter “a” will be used. It will be appreciated that the structure and function of the second latch bolt 120b may be substantially the same as the first latch bolt 120a, except that the second latch bolt 120b is provided at the second end 112 of the upper rail 108. In the figures, the second latch bolt 120b has been numbered with the same reference numerals as used for the first latch bolt 120a, but ending with the letter “b”.

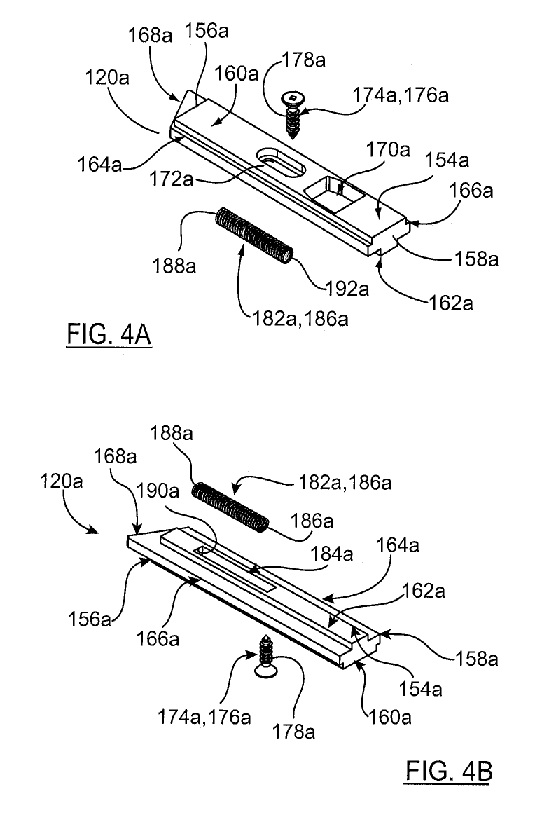

As shown in FIGS. 4A and 4B, the first latch bolt 120a is an integrally formed one-piece member. The first latch bolt 120a has a body portion 154a which extends between first 156a and second 158a opposed ends. The body portion 154a has a top 160a, a bottom 162a, and first 164a and second 166a opposed sides, each of which extends between the first 156a and second 158a opposed ends.

An engagement end 168a is provided at the first end 156a of the body portion 154a. In the example shown, the engagement end 168a comprises a nose extending laterally outwardly from the first end 156a of the body portion 154a.

A grip portion 170a is provided at the top 160a of the body portion 154a. In the example shown, the grip portion 170a is an indentation into which a user's finger may be inserted for manipulation of the first latch bolt 120a. In some examples, a button or other control (not shown) may be mounted to the indentation after the latch bolt 120a is inserted into the channel 120a.

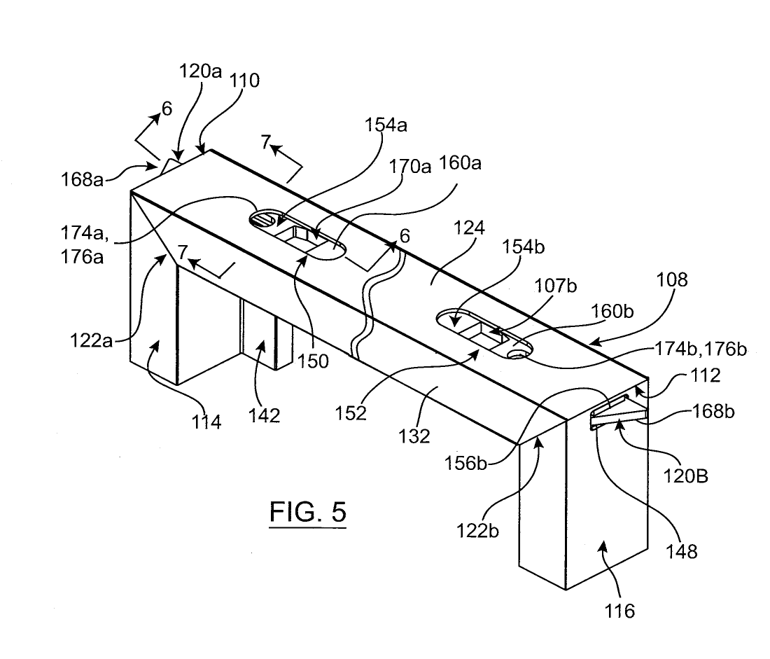

As shown in FIGS. 5-7, the first latch bolt 120a is slidably received in the channel 144 of the upper rail 108, and is seated on the upper seating surface 136. More particularly, the bottom 160a of the body portion 154a is seated on the upper seating 136 surface. Additionally, the body portion 154a is positioned between the first 138 and second 140 support ribs, which centre the first latch bolt within the channel 144, between the front 130 and back 132 walls.

Referring still to FIGS. 4A-7, in the example shown, the body portion 154a is secured to the upper seating surface 136. More particularly, as shown, the first latch bolt 120a comprises an elongated slot 172a extending vertically therethrough. A first slide pin 174a is provided, which extends through the slot 172a, and is secured to the intermediate wall 128. In the example shown, the first slide pin 174a is a screw 176a, and the shaft 178a of the screw extends through the slot 172a and is screwed through the intermediate wall 128a, into a lower channel 180 between the intermediate wall 128 and the lower wall 126. The first latch bolt 120a is slidable along the first slide pin 174a.

The first latch bolt 120a is positioned in the channel 144 such that the grip portion 170a is aligned with the first opening 150 and is accessible through the first opening 150. For example, a user's finger may be inserted through the opening 150 and into the indentation to grip the grip portion 170a, or a button may extend through the opening, and a user may grip the button.

Using the grip portion 170a, the first latch bolt 120a is slidable through the channel 144 along the slide pin 174a between a locking position, shown in FIG. 6A, and an unlocking position, shown in FIG. 6B. In the locking position, the engagement end 168a extends proud of the first end 110a of the upper rail 108 for engagement with the master frame 104 in which the window sash frame 100 is mounted. In the example shown, as mentioned hereinabove, the upper rail 108 is joined to the first side rail 114 at a miter joint 122a. Accordingly, in the locking position, the engagement end 168a extends proud of the aperture 146 in the first side rail 114. An aperture or other mating engagement member (not shown) may be provided in the master frame 104, for locking engagement with the engagement end 168a. Accordingly, when the first latch bolt 120a is in the locking position, the window sash frame 100 may not be pivoted open. In the unlocking position, the engagement end 168a is retracted towards the second end 112 of the upper rail 108. For example, the engagement end may be retracted shy of the aperture 146 as shown, or all the way into the channel 144. Accordingly, in the unlocking position, the window sash frame 100 may be pivoted open.

Preferably, a first biasing member 182a is provided which biases the first latch bolt 120a towards the locking position. For example, as shown in FIGS. 4A-4B and 6A-6B, the first latch bolt comprises a horizontally extending recess 184a, which is open to the bottom 160a thereof. The recess 184a provides a lower portion of the elongated slot 172a, so that the first slide pin 174a extends through the recess 184a. A horizontally extending spring 186a is received in the recess 184a. The spring has a first end 188a, which bears against an end 190a of the recess, and a second end 192a, which bears against the slide pin 174a. When the latch bolt 120a is slid to the unlocking position, the spring 186a is compressed between the end 190a of the recess 184a and the slide pin 174a. When the latch bolt is released, the spring relaxes and 186a biases the latch 120a to the locking position.

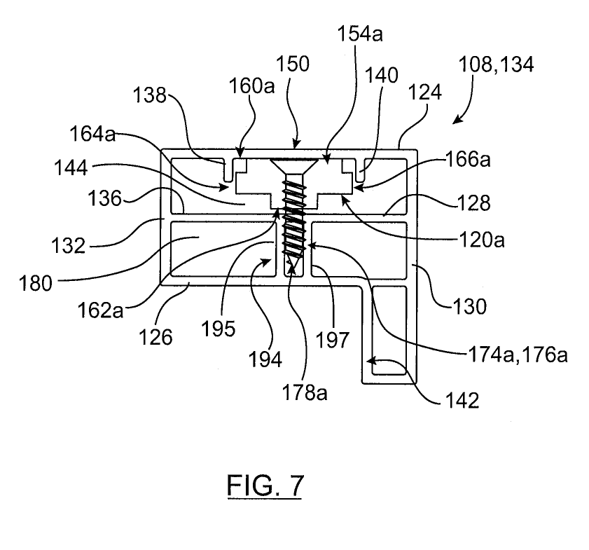

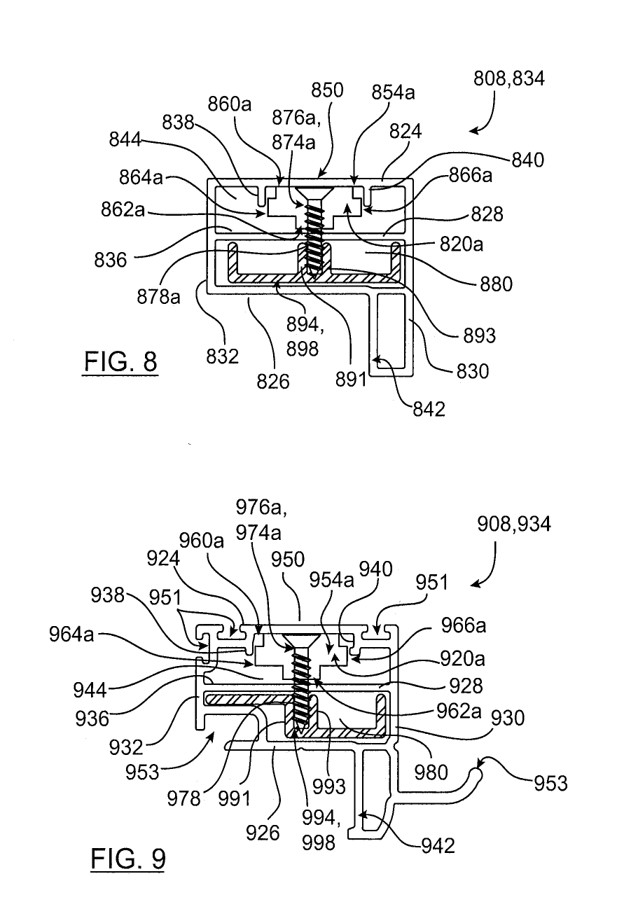

In some examples, a screw support 194 is provided in the lower channel 180, which supports the screw 176a. For example, referring to FIG. 7, a screw support 194 is provided which comprises first 195 and second 197 ribs, which are integrally formed with the upper rail 180 and extend between the intermediate wall 128 and the lower wall 126. The screw 176 is screwable into the screw support 194, between the ribs 195, 197. An alternate example is shown in FIG. 8, wherein like numerals are used to refer to like elements of FIGS. 1-7, with the first digit incremented to 8 to refer to the Figure number. In this example, the screw support 894 comprises an insert 898, which is formed separately from the upper rail 808, and is inserted into the lower channel 880. The insert comprises first 891 and second 893 upwardly extending ribs, between which the screw may be secured. The insert may also be formed by extrusion, and may extend along the length of the lower channel 880, so that it may also support the second screw 176b.

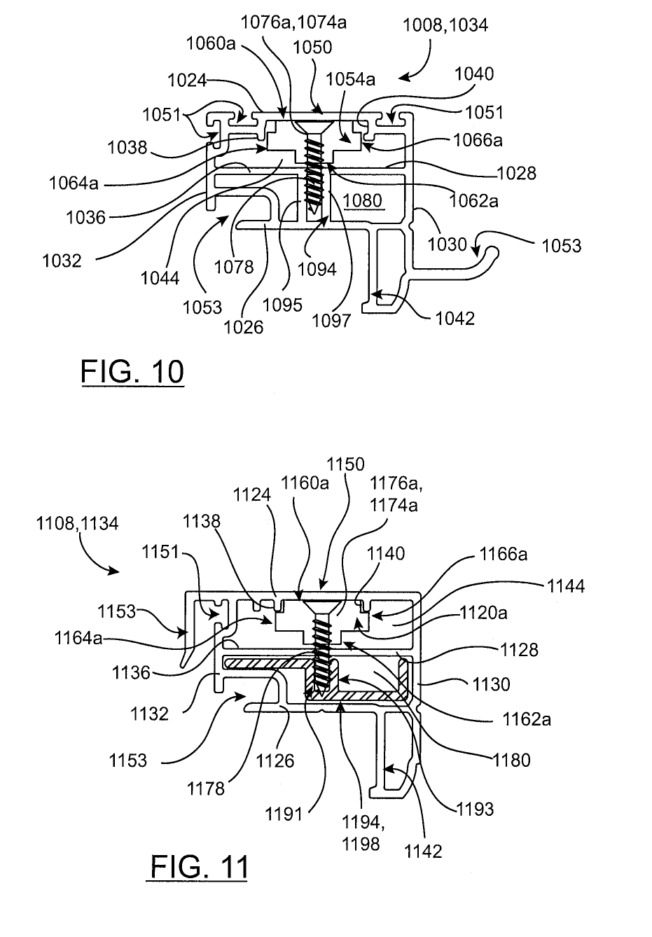

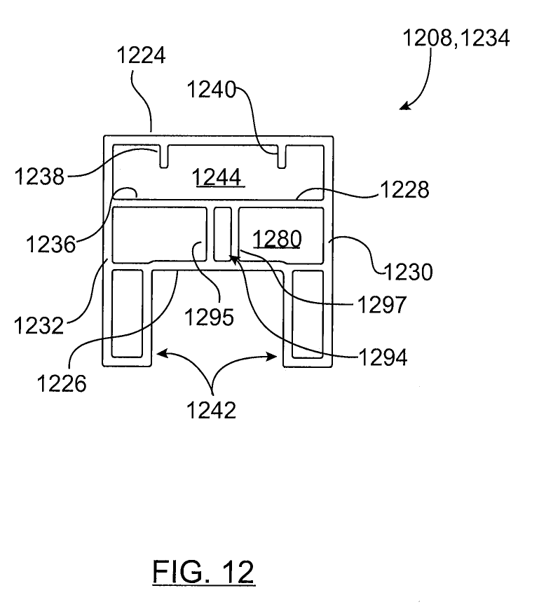

Referring now to FIGS. 9-12, alternate extrusion profiles of upper rail 108 are shown. In FIGS. 9-12 like numerals are used to refer to like elements of FIGS. 1-8, with the first digit(s) incremented to refer to the Figure number. In the examples of FIGS. 9-11, the extrusion profiles 934, 1034, and 1134, respectively, include various weather stripping pockets 951, 1051, 1151, and function engagement hooks 953, 1053, 1153. In the examples of FIGS. 9 and 11, an alternate example of a screw support insert 998, 1198 is shown. In the example of FIG. 12, an alternate example of a glazing support 1242 is shown.

As mentioned hereinabove, in the examples shown, the window sash frame 100 comprises first 120a and second 120b latch bolts. In alternate examples, only a single latch bolt may be provided.

As mentioned hereinabove, in the examples shown, the latch bolts 120a, 120b seat on the upper seating surface 136. In alternate examples, the latch bolts 120a, 120b may not seat on the upper seating surface 136. For example, a coating or an insert may be provided between the upper seating surface 136 and the latch bolts 120a, 120b.

As mentioned hereinabove, in the examples shown, the latch bolts 120a, 120b are secured to the intermediate wall 128 with slide pins 174a, 174b, respectively. In alternate embodiments, the latch bolts 120a, 120b may not be secured to the intermediate surface 128.

It will be appreciated that the first 120a and second 12b latch bolts may be inserted into the channel 144 either before or after the upper rail 108 is assembled to the first 114 and second side rails 116.

1. A window sash frame comprising:
a) a horizontally extending upper rail comprising:
i) a first end and a laterally opposed second end;
ii) an integrally formed upper wall, lower wall, intermediate wall, front wall, and back wall extending between the first end and second end, the upper wall, lower wall, and intermediate wall extending parallel to the horizontal plane, and the front wall and back wall extending parallel to the vertical plane;
iii) the intermediate wall comprising an upper seating surface facing the upper wall;
iv) the upper wall, intermediate wall, front wall and back wall defining a horizontally extending channel within the upper rail; and
v) a first opening in the upper wall providing access to the channel;
b) a first latch bolt slidably received in the channel and seated on the upper seating surface, the first latch bolt comprising:
i) an engagement end; and
ii) a grip portion aligned with the opening and accessible through the opening, the grip portion being usable to slide the first latch bolt between a locking position wherein the engagement end extends proud of one of the first end and the second end of the upper rail for engagement with a master frame in which the sash is mounted, and an unlocking position wherein the engagement end is retracted towards the other of the first end and the second end;
c) a first biasing member biasing the first latch bolt towards the locking position; and
d) a first vertically extending side rail and a second vertically extending side rail extending downward from the first and second ends of the upper rail, respectively, and a horizontally extending lower rail extending between the first and second side rails opposite the upper rail.

2. The window sash frame of claim 1, wherein the first latch bolt comprises a lower surface, and a horizontally extending recess open to the lower surface, and the first biasing member comprises a horizontally extending spring received in the recess.

3. The window sash frame of claim 2, wherein the first latch bolt further comprises an elongated slot extending vertically therethrough, and the window sash frame further comprises a slide pin extending vertically through the slot and secured to the intermediate wall, wherein the first latch bolt is slidable along the slide pin.

4. The window sash frame of claim 3, wherein a portion of the recess provides a lower portion of the elongated slot so that the slide pin extends through the recess, and the spring bears against the slide pin at one end thereof.

5. The window sash frame of claim 4, wherein the slide pin comprises a screw portion.

6. The window sash frame of claim 5, wherein a lower channel is defined between the intermediate wall and the lower wall, and the screw portion extends through the intermediate wall into the lower channel.

7. The window sash frame of claim 6, further comprising a screw-support in the lower channel, the screw portion being screwed into the screw-support.

8. The window sash frame of claim 7, wherein the screw-support comprises first and second ribs integrally formed with the upper rail and extending between the intermediate wall and the lower wall.

9. The window sash frame of claim 1, wherein the first opening is proximate the first end, and the engagement end extends proud of the first end in the locking position.

10. The window sash frame of claim 9, wherein the first side rail has an aperture extending horizontally therethrough and aligned with the channel, and wherein the engagement end is slidable through the aperture and is positioned proud of the first side rail in the locking position.

11. The window sash frame of claim 9, further comprising:
a) a second opening proximate the second end and providing access to the channel;
b) a second latch bolt slidably received in the channel and seated on the lower seating surface, the second latch bolt comprising:
i) second latch bolt engagement end;
ii) second latch bolt grip portion aligned with the second opening and accessible through the second opening, the second latch bolt grip portion being usable to slide the second latch bolt between a second latch bolt locking position wherein the second latch bolt engagement end extends proud of the second end of the upper rail for engagement with the window frame, and a second latch bolt unlocking position wherein the second latch bolt engagement end is retracted towards the first end; and
c) a second biasing member biasing the second latch bolt towards the locking position.

12. A window sash frame comprising:
a) a horizontally extending upper rail comprising:
i) a first end and a longitudinally opposed second end;
ii) an integrally formed upper wall, lower wall, intermediate wall, front wall, and back wall extending between the first end and second end, the upper wall, lower wall, and intermediate wall extending parallel to the horizontal plane, and the front wall and back wall extending parallel to the vertical plane;
iii) the upper wall, intermediate wall, and front and back walls defining a horizontally extending channel within the upper rail; and
iv) a first opening in the upper wall providing access to the channel;
b) a first latch bolt slidably received in the channel and comprising:
i) an engagement end;
ii) an elongated slot extending vertically therethrough; and
iii) a grip portion aligned with the first opening and accessible through the opening; and
c) a first slide pin extending through the slot and secured to the intermediate wall, the first latch bolt being horizontally slidable along the first slide pin using the grip portion between a locking position wherein the engagement end extends proud of one of the first end and the second end of the upper rail for engagement with a master frame in which the sash is mounted, and an unlocking position wherein the engagement end is retracted towards the other of the first end and the second end;
d) a first biasing member biasing the first latch bolt towards the locking position; and
e) a first vertically extending side rail, and a second vertically extending side rail extending downward from the first and second ends of the upper rail, and a lower horizontal rail extending between the first and second side rails opposite the upper rail.

13. The window sash frame of claim 12, wherein the first latch bolt comprises a lower surface and a horizontally extending recess open to the lower surface, and the first biasing member comprises a horizontally extending spring received in the recess.

14. The window sash frame of claim 13, wherein a portion of the recess provides a lower portion of the elongated slot so that the first slide pin extends through the recess, and the spring bears against the first slide pin at one end thereof.

15. The window sash frame of claim 12, wherein the first opening is proximate the first end, and the engagement end extends proud of the first end in the locking position.

16. The window sash frame of claim 15, wherein the first side rail has an aperture extending horizontally therethrough and aligned with the channel, and wherein the engagement end is slidable through the aperture and extends proud of the first side rail in the locking position.

17. The window sash frame of claim 15, further comprising:
a) a second opening proximate the second end and providing access to the channel;
b) a second latch bolt slidably received in the channel and comprising:
i) a second latch bolt engagement end;
ii) a second latch bolt elongated slot extending vertically therethrough;
iii) a second latch bolt grip portion aligned with the second opening and accessible through the second latch bolt opening;
c) a second fastener extending through the second latch bolt slot and secured to the intermediate wall, the second latch bolt being horizontally slidable along the second fastener using the second latch bolt grip portion between a second latch bolt locking position wherein the second latch bolt engagement end extends proud of the second end of the upper rail for engagement with the window frame, and a second latch bolt unlocking position wherein the second latch bolt engagement end is retracted towards the channel; and
d) a second biasing member biasing the second latch bolt towards the second locking position.

18. The window sash frame of claim 12, wherein the grip portion is a downwardly extending indentation.

19. The window sash frame of claim 18, further comprising an upwardly extending button mounted to the grip portion and extending through the opening.

20. The window sash frame of claim 12, wherein the intermediate wall comprises an upper seating surface facing the upper wall, and the latch bolt is seated on the upper seating surface.
